(19) United States
(12) Patent Application Publication
(10) Pub. No.: US 2024/0062926 A1
(43) Pub. Date: Feb. 22, 2024

(54) Method of actinum-225 production

(71) Applicant: Alexander Lintehevsky, TEL AVIV (IL)

(72) Inventor: Alexander Lintehevsky, TEL AVIV (IL)

(21) Appl. No.: 17/889,007

(22) Filed: Aug. 16, 2022

(51) Int. Cl. G21G 1/10

(52) U.S. Cl. CPC G21G 1/10

(57) ABSTRACT

An objective of this invention is to ensure, under the thorium irradiation with protons, the actinium-225 radiochemical purity in relation to actinium-227 in such a way that the activity of the latter does not exceed several hundredths of percent in relation to the target radionuclide's activity. The problem is solved by the irradiation of thorium metal plates with a thickness of 0.5 to 1.5 mm under a current of at least 300 μA with protons in the narrow energy range of 40 to 80 MeV.

### FIELD OF INVENTION

The present invention relates to a field of nuclear technology, the radionuclide production, and for medical purposes, in particular, the in present invention concerns the production of isotopically pure actinium-225, which is used for alpha radiotherapy.

### BRIEF DESCRIPTION OF THE PRIOR ART

There is a known method for actinium-225 production, including the irradiation of natural thorium metal targets with protons of the energy more than 80 MeV [M. Lefort et al. Reactions nucleaires de spallation induites sur le thorium par des protons de 150 et 82 MeV. Nuclear Physics, 1961. V. 25. P. 216-247]. The disadvantage of the method is the application of thorium metal in the form of a foil up to 0.05 mm thick, that is, a thorium target of small weight, which cannot provide a high actinium production yield. In addition, the proton energy range used from 82 to 150 MeV a priori leads to the formation of actinium-225, noticeably contaminated with actinium-227. There is a known method for actinium-225 production, including natural metallic thorium targets irradiation by protons with energy of more than 40 MeV at the current of several tens of μA. [R. A. Aliev et al. Isolation of medicine-applicable actinium-225 from thorium targets irradiated by medium-energy protons. Solvent Extraction and Ion Exchange. 2014. V. 32. P. 468-477].

The disadvantage of the method is the application of thorium metal in the form of a foil or plates with a thickness from 2.6 to 3.0 mm, which, in the case of foil, cannot provide a high actinium production yield due to the small mass of the thorium target. In the case of the thick plate's application, the degradation of proton energy is observed in them, which, along with the application of protons in the energy range from 90 to 141 MeV, leads to a severe contamination of actinium-225 with actinium-227, as high as 0.1% of the actinium-225 activity under the optimum irradiation conditions. In addition, a low 50 μA current requires, all other things being equal, an increase in the radiation exposure time, which also leads to increased contamination of actinium-225 with actinium-227.

The closest in technical essence to the claimed solution chosen as a prototype is the actinium-225 production method, which includes the irradiation of natural thorium metal targets with protons at energy more than 80 MeV and a current of several tens of μA. [B. L. Djuykov et al. Sposob poluchenya actinium-225 & Ra isotopes and production target (variants). RF Patent No. 2373589. Publ. Nov. 20, 2009. Bulletin No. 32]. The disadvantage of this method is the application of targets in the form of plates of 2 to 30 mm thickness. Under these conditions, a noticeable degradation of proton energy in the targets occurs, which, along with the application of protons in the energy range of 80 to 110 MeV, leads to the severe contamination of the target actinium-225 with the spurious actinium-227, as high as 0.1% of the actinium-225 activity under the optimum irradiation conditions.

In addition, a low current used in the range from 70 to 100 μA requires, all other things being equal, an increase in the radiation exposure time, which also leads to an increased contamination of actinium-225 with actinium-227.

Unfortunately, these prior art methods have numerous disadvantages. There is always a need for an improved methods for production actinium-225 production.

### SUMMARY OF THE INVENTION

A method for actinium-225 production, including irradiation of the natural thorium metal targets by protons with an energy more than 40 MeV at a current of several tens of μA, characterized in that the irradiated thorium plates have a thickness of 0.5 to 1.5 mm, and irradiation is carried out with at least 300 μA current, by protons within a narrow energy range of 40 to 80 MeV.

The objective of this technical solution is to ensure, under the thorium irradiation with protons, the actinium-225 radiochemical purity in relation to actinium-227 in such a way that the activity of the latter does not exceed several hundredths of percent in relation to the target radionuclide's activity.

The problem is solved by the irradiation of thorium metal plates with a thickness of 0.5 to 1.5 mm under a current of at least 300 μA with protons in the narrow energy range of 40 to 80 MeV.

An advantage of the present invention compared to the prototype is to provide the ratio of the accumulated activities of the target Ac-225 radionuclide to the main pollutant Ac-227 is −5.103 (the prototype gives 8.102).

Another advantage of the present invention is to provide the production of fewer long-lived pollutants compared to the prototype since the radionuclide production takes place at lower proton energies, at which many channels of pollutants production are close.

Still another advantage of the present invention is the small optical thickness of the target compared to the prototype that does not change the proton energy and does not take them out of the range of the optimal ratio of the production cross-sections, and the yield of Ac-227 does not increase (outside the proposed energy range, the cross-sections of Ac-225 and Ac-227 converge and the positive effect decreases).

Still another advantage of the present invention compared to the prototype is a sufficiently large proton current at radionuclide production (hundreds of microamps) that also works for a positive effect: for the same production of Ac-225 for the prototype, a longer irradiation is required, in which there is a greater accumulation of long-lived Ac-227.

### DETAILED DESCRIPTION OF THE INVENTION

Referring to description of the present invention, the words “inner”, “inwardly” and “outer”, “outwardly” refer to directions toward and away from, respectively, a designated centerline or a geometric center of an element being described, the particular meaning being readily apparent from the context of the description. Additionally, as used herein, the singular forms “a,” “an,” and “the” include plural referents unless the context clearly dictates otherwise.

These example embodiments, which are also referred to herein as “examples,” are described in enough detail to enable those skilled in the art to practice the present subject matter. The embodiments can be combined, other embodiments can be utilized, or structural, logical and operational changes can be made without departing from the scope of what is claimed. The following detailed description is, therefore, not to be taken in a limiting sense, and the scope is defined by the appended claims and their equivalents.

Alluding to the above, for purposes of this patent document, the terms “or” and “and” shall mean “and/or” unless stated otherwise or clearly intended otherwise by the context of their use. The term “a” shall mean “one or more” unless stated otherwise or where the use of “one or more” is clearly inappropriate. The terms “comprise,” “comprising,” “include,” and “including” are interchangeable and not intended to be limiting. For example, the term “including” shall be interpreted to mean “including, but not limited to.”

A method for actinium-225 production, including irradiation of the natural thorium metal targets by protons with an energy more than 40 MeV at a current of several tens of μA, characterized in that the target thorium plates have a thickness of 0.5 to 1.5 mm, and irradiation is carried out with a current at least 300 μA, by protons within an energy range of 40 to 80 MeV.

The irradiation energy deviation from the specified energy range (40÷80 MeV) leads to a sharp decrease and further to the disappearance of the positive effect—the radiochemical purity of actinium-225 in relation to actinium-227.

A decrease in the target thickness below 0.5 mm is unreasonable, as it reduces the target actinium-225 production yield, all other things being equal; as well, an increase in the target thickness more than 1.5 mm shifts the proton energy out of the optimum range. A decrease in the current below 300 μA leads to the need for longer irradiation to obtain the required amount of actinium-225 produced and to a disproportional increase in the simultaneous accumulation of actinium-227 in the target. Hence, the target nuclide purity according to this factor decreases. The upper limit of the current is not set, as this value is defined by the capabilities of the accelerator equipment only.

A combination of the significant factors of the actinium-225 production process in accordance with the claimed technical solution, namely, a range of target thicknesses that eliminates the degradation of proton energies, the use of the proton flux in the specified narrow energy range, and the current of at least 300 μA, provides a new unexpected effect: achieving the actinium-225 radiochemical purity in relation to actinium-227 of 5-6 times higher than those of well-known products, other things being equal, which makes it possible to recognize the claimed technical solution as meeting the “non-obviousness” requirement.

A new unexpected positive effect is implemented under almost any reasonable from a practical point of view irradiation time, which is confirmed by the data in Table 1. Table 1—The Ac-227 activity percentage in the summarized activity Ac-225 and Ac-227

| Exposure | Ac-227 activity to total actinium activity, % | | Positive |
|---|---|---|---|
| time, | According to the | According to the claimed | effect, |
| d | closest analogue | technical decision | times |
| 1 /24 | 0.116 | 0.020 | 5.8 |
| 1/10 | 0.118 | 0.020 | 5.9 |
| 1 | 0.121 | 0.021 | 5.8 |
| 10 | 0.163 | 0.028 | 5.8 |
| 30 | 0.278 | 0.048 | 5.8 |

The possibility of implementing the claimed technical solution is confirmed by the following embodiments.

Example 1: The thickness of the target made of natural thorium metal is 0.5 mm. The target is irradiated by a proton beam with the energy of 45 MeV at a 300 μA current. After irradiation, the ratio of actinium-227 activity to that of the actinium-225 in the target is 0.033%.

Example 2: The thickness of the target made of natural thorium metal is 1.5 mm. The target is irradiated by a proton beam with the energy of 55 MeV at a 500 μA current. After irradiation, the ratio of actinium-227 activity to that of the actinium-225 in the target is 0.020%.

The data presented in the table and examples confirm the claimed effect of achieving the actinium-225 radiochemical purity in relation to actinium-227 at the level of hundredths percent of pollutants in the target radionuclide activity, which is 5-6 times higher, all other things being equal, than that of the products known to date.

Referring now to the drawings and the illustrative embodiments depicted therein, various embodiments of the invention comprise systems and methods for providing an analytical testing system and method for vaping devices to control the stability of a vaping device operation by defining a group of parameters.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. (canceled)

2. (canceled)

3. A target natural thorium ²³²Th metal plate with a thickness of 1.0 to 1.5 mm intended to produce ²²⁵Ac by irradiating it by protons within a narrow energy range of 40 to 65 MeV and at a current of at least 300 μA and exposure time from 1 hour to 10 days.
